(19) United States
(12) Patent Application Publication
(10) Pub. No.: US 2007/0032570 A1
(43) Pub. Date: Feb. 8, 2007

(54) Ink comprising a block copolymer dispersing agent having a hydrophilic and a hydrophobic segment and an ink-applying process and apparatus using the same

(75) Inventors: Koichi Sato, Kanagawa-ken (JP); Ikuo Nakazawa, Kanagawa-ken (JP); Hitoshi Inoue, Ibaraki-ken (JP); Tomoya Yamamoto, Ibaraki-ken (JP); Yukiko Tachibana, Ibaraki-ken (JP)

Correspondence Address: FITZPATRICK CELLA HARPER & SCINTO, 30 ROCKEFELLER PLAZA, NEW YORK, NY, 10112, US

(73) Assignees: Canon Kabushiki Kaisha, Tokyo (JP); Canon Finetech Inc., Mitsukaido-shi (JP)

(21) Appl. No.: 10/554,918

(22) PCT Filed: Nov. 10, 2004
(86) PCT No.: PCT/JP04/17038

§ 371 Date: Oct. 31, 2005

(30) Foreign Application Priority Data
Nov. 11, 2003 (JP) 2003-381041

(51) Int. Cl. C03C 17/00

(52) U.S. Cl. 523/160

(57) ABSTRACT

Disclosed herein is an ink comprising a coloring agent composed of composite particles of a coloring material and inorganic fine particles, a polymeric dispersing agent and a solvent, wherein the polymeric dispersing agent is composed of a block copolymer of a polyvinyl ether structure having a hydrophilic segment and a hydrophobic segment.

### TECHNICAL FIELD

The present invention relates to an ink, and an ink-applying process and an ink-applying apparatus using this ink.

### BACKGROUND ART

Water-based inks are principally used as inks for ink-jet printers which have become widely used with the spread of computers from the viewpoint of safety and the like. Among these, water-based inks using a water-soluble dye are most spread because of their excellent coloring ability. However, the water-based inks using such a water-soluble dye involve problems that they are poor in water fastness because the dye is soluble in water, and that they are rapidly deteriorated by light or gasses such as ozone because the dye is in a molecular state.

In order to solve these problems, an investigation is carried out as to inks using an insoluble coloring material such as a pigment, which is in such a form that a plurality of molecules are agglomerated, and not in the state of a molecule (see

U.S. Pat. Nos. 5,085,698 and 5,714,538). These dispersed type inks are superior in the so-called image fastness properties such as water fastness, light fastness and gas fastness compared to inks using a water-soluble coloring matter, but are required to improve the storage stability and coloring ability of the dispersion because particles of the coloring material are big and hence liable to be aggregated.

It is therefore performed to use inorganic particles which are comparatively easily formed into fine particles as a carrier and combine this carrier with a coloring material (see U.S. AA 20020069790). A pigment, which is difficult to be formed into fine particles by itself, can be made in a state of fine particles by this method, and so the storage stability and coloring ability can be improved while retaining high image fastness properties. However, the inorganic particles are easy to precipitate in a medium because of their high specific gravity. It is thus required to more improve the storage stability.

### DISCLOSURE OF THE INVENTION

The present invention has been made in view of the foregoing circumstances and has as its object the provision of an ink which can provide prints high in image fastness properties such as water fastness and light fastness and is excellent in coloring ability and storage stability.

Another object of the present invention is to provide an ink-applying process and an ink-applying apparatus, by which the above-described ink can be stably applied to a recording medium.

The above objects can be achieved by the present invention described below.

In an aspect of the present invention, there is thus provided an ink comprising a coloring agent composed of composite particles of a coloring material and inorganic fine particles, a polymeric dispersing agent and a solvent, wherein the polymeric dispersing agent is composed of a block copolymer of a polyvinyl ether structure having a hydrophilic segment and a hydrophobic segment.

In another aspect of the present invention, there is provided an ink-applying process comprising the step of applying the ink described above to a recording medium.

In a further aspect of the present invention, there is provided an ink-applying apparatus comprising an ink-applying means for applying the ink described above to a recording medium by applying energy to the ink, and a driving means for driving the ink-applying means.

According to the present invention, there can be provided an ink which can provide prints high in image fastness properties such as water fastness and light fastness and is excellent in coloring ability and storage stability.

According to the present invention, there can also be provided an ink-applying process and an ink-applying apparatus, by which the above-described ink can be stably applied to a recording medium.

### BRIEF DESCRIPTION OF THE DRAWINGS

FIG. 1 schematically illustrates the mechanism of an image-recording apparatus according to the present invention.

### BEST MODE FOR CARRYING OUT THE INVENTION

The present invention will hereinafter be described in more detail by the preferred embodiments.

A first embodiment of the present invention relates to an ink comprising a coloring agent composed of composite particles of a coloring material and inorganic fine particles, a polymeric dispersing agent and a solvent, wherein the polymeric dispersing agent is composed of a block copolymer of a polyvinyl ether structure having a hydrophilic segment and a hydrophobic segment.

The block copolymer used in the present invention acts as a dispersing agent in the ink for stably dispersing the composite particles of the coloring material and the inorganic fine particles and has an effect to fix the coloring material to a recording medium such as paper after the ink is applied to the recording medium.

The block copolymer used in the present invention is a copolymer each having at least one hydrophilic segment (A) and hydrophobic segment (B). The block copolymer of the polyvinyl ether structure having the hydrophilic segment and the hydrophobic segment can include a water-insoluble coloring agent in its interior to stably disperse the coloring agent in a hydrophilic medium because the hydrophobic segment interacts with the water-insoluble coloring agent, while the hydrophilic segment has a strong force leading to be dissolved in the hydrophilic medium. This effect is useful for particles having a high specific gravity, and so a stable dispersion free of aggregation between particles can be formed even when composite particles obtained by combining a coloring material with inorganic fine particles are used. As a result, a water-based ink excellent in image fastness properties, coloring ability, dispersion stability and storage stability can be obtained.

No particular limitation is imposed on the configuration of the respective segments in the block copolymer. However, the hydrophilic segment is preferably located at a terminal of a polymer chain from the viewpoint of enhancing the dispersibility of the coloring agent. Examples of the block form include AB, ABA′ (A and A′ may be the same or different from each other), AA′B and BB′A types. A, A′, B and B′ are segments of a homopolymer or copolymer.

The block copolymer used in the present invention is a block copolymer containing a hydrophilic segment composed of a homopolymer or copolymer of a vinyl ether type monomer and a hydrophobic segment composed of a homopolymer or copolymer of a vinyl ether type monomer.

These polymers preferably have a repeating unit structure represented by the following general formula (1)

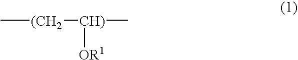

In the general formula (1), R¹ is an aliphatic or alicyclic hydrocarbon group such as an alkyl, alkenyl, cycloalkyl or cycloalkenyl group, or an aromatic hydrocarbon group, the carbon atom of which may be substituted by a nitrogen atom, such as a phenyl, pyridyl, benzyl, toluyl, xylyl, alkylphenyl, phenylalkylene, biphenyl or phenylpyridyl group. A hydrogen atom on the aromatic ring may be substituted by a hydrocarbon group. R¹ preferably has 1 to 18 carbon atoms.

R¹ may be a group represented by —(CH(R²)—CH(R³)—O)ₚ—R⁴ or —(CH₂)ₘ—(O)ₙ—R⁴. In this case, R² and R³ are, independently of each other, hydrogen or methyl, R⁴ is an aliphatic or alicyclic hydrocarbon group such as an alkyl, alkenyl, cycloalkyl or cycldalkenyl group, an aromatic hydrocarbon group, the carbon atom of which may be substituted by a nitrogen atom (a hydrogen atom on the aromati/c ring may be substituted by a hydrocarbon group), such as a phenyl, pyridyl, benzyl, toluyl, xylyl, alkylphenyl, phenylalkylene, biphenyl or phenylpyridyl group, —CHO, —CH₂CHO, —CO—CH═CH₂, —CO—C(CH₃)═CH₂, —CH₂—CH═CH₂, —CH₂—C(CH₃)═CH₂, or —CH₂—COOR⁵, with the proviso that hydrogen atoms in each group may be substituted by halogen atoms such as fluorine, chlorine and bromine within limits chemically permitted, and R⁴ preferably has 3 to 18 carbon atoms, R⁵ is hydrogen or an alkyl group, p is preferably 1 to 18, m is preferably 1 to 36, and n is preferably 0 or 1.

In R¹ and R⁵, examples of the alkyl and alkenyl groups include methyl, ethyl, propyl, isopropyl, n-butyl, sec-butyl, t-butyl, pentyl, hexyl, heptyl, octyl, nonyl, decyl, dodecyl, tetradecyl, hexadecyl, octadecyl, oleyl and linoleyl groups, and examples of the cycloalkyl and cycloalkenyl groups include cyclopropyl, cyclobutyl, cyclopentyl, cyclohexyl, cyclooctyl and cyclohexenyl groups.

The structures of monomers (I-a to I-o) and polymers (II-a to II-e) containing the repeating unit represented by the general formula (1) described above are illustrated below. However, the polyvinyl ether structures used in the present invention are not limited thereto.

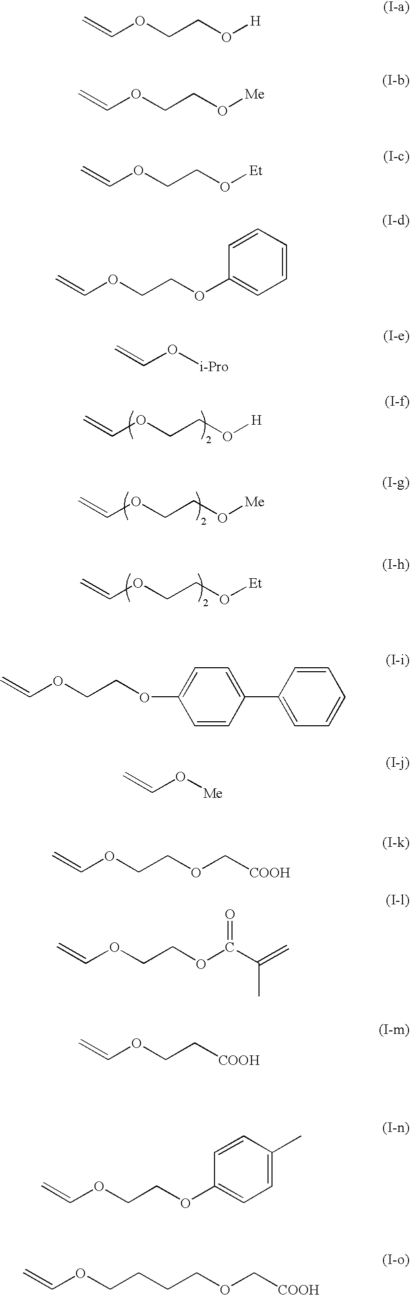

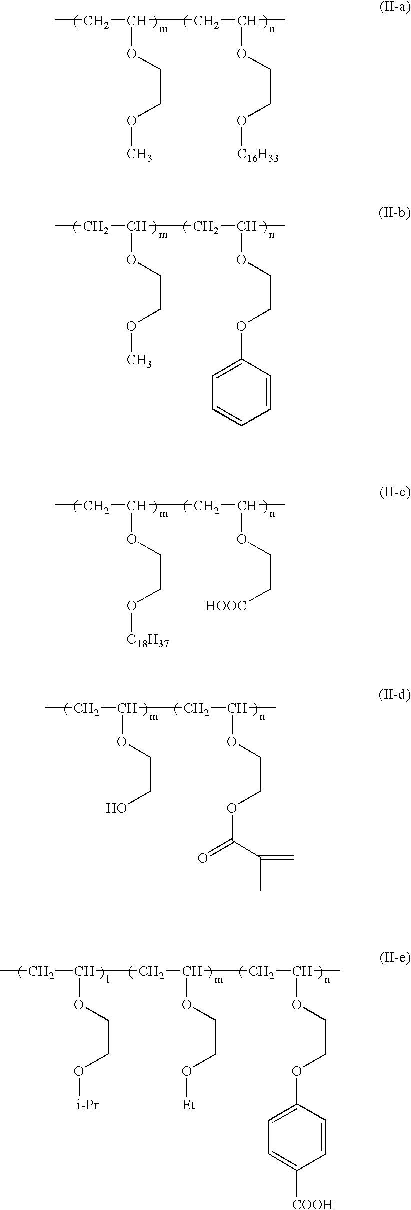

In the monomers (I-a to I-o) making up the repeating unit represented by the general formula (1), monomers making up the hydrophilic segment are, for example, I-a, I-k and I-o, and monomers making up the hydrophobic segment are, for example, I-d, I-e and I-i.

Proportions of the hydrophilic segment and hydrophobic segment contained in the block copolymer having the polyvinyl ether structure in the present invention are preferably 10 to 90% by mole and 90 to 10% by mole, respectively.

The numbers [m, n and 1 in the polymers (II-a) to (II-e)] of repeating units of the polyvinyl ether are preferably, independently of one another, 1 to 10,000. The total number [m+n+1 in the polymers (II-a) to (II-e)] thereof is preferably 10 to 20,000. The number average molecular weight of the polymer is preferably 500 to 20,000,000, more preferably 1,000 to 5,000,000, most preferably 2,000 to 2,000,000.

These polyvinyl ethers may be graft-bonded to another polymer or copolymerized with another repeating unit structure. Each block also includes a copolymer of a vinyl ether type monomer and any other monomer than it.

No particular limitation is imposed on a synthesizing process of the copolymer having a vinyl. ether type polymer block. However, cationic living polymerization by Aoshima, et al (Japanese Patent Application Laid-Open Nos. H11-322942 and H11-322866), or the like is preferably used. By using the cationic living-polymerization process, various polymers such as homopolymers, copolymers composed of two or more monomers, block polymers, graft polymers and graduation polymers can be synthesized with their chain lengths (molecular weights) exactly made uniform. Further, in the polyvinyl ether, various functional groups can be introduced into side chains thereof.

The proportion of the block copolymer contained in the ink in the present invention is preferably 0.001 to 40% by weight, more preferably 0.01 to 20% by weight based on the total weight of the ink. When the amount of the block copolymer is 0.001 to 40% by weight, the resulting ink can provide an image having preferable rub-off resistance, and exhibits preferable ejection stability because the viscosity of the ink does not become too high.

The coloring agent used in the present invention is composite particles of a coloring material and inorganic fine particles. The coloring agent used may be a water-insoluble coloring agent.

As the coloring material, may be used a dye, pigment or the like. However, the pigment is preferred. Examples of commercially available pigments in black, cyan, magenta and yellow are mentioned below.

As examples of black pigments, may be mentioned Raven 1060 (product of Columbian Carbon Japan Limited), MOGUL-L (product of Cabot Company), Color Black FW1 (product of. Degussa AG) and MA100 (product of Mitsubishi Chemical Corporation). However, the present invention is not limited thereto.

As examples of cyan pigments, may be mentioned C.I. Pigment Blue 15:3, C.I. Pigment Blue 15:4 and C.I. Pigment Blue 16. However, the present invention is not limited thereto.

As examples of magenta pigments, may be mentioned C.I. Pigment Red 122, C.I. Pigment Red 123 and C.I. Pigment Red 146. However, the present invention is not limited thereto.

As examples of yellow pigments, may be mentioned C.I. Pigment Yellow 74, C.I. Pigment Yellow 128 and C.I. Pigment Yellow 129. However, the present invention is not limited thereto.

As the inorganic fine particles used in the present invention, may be applied oxides, nitrides, chlorides, sulfates, carbonates, etc. Specific examples thereof include silica, alumina, titanium oxide, zinc oxide, zirconium oxide, iron oxide, nickel oxide, copper oxide, barium sulfate and calcium carbonate. Among these, silica, alumina, titanium oxide, zinc oxide and the like that are oxides are preferred. Examples of a process for obtaining particles of these oxides include a precipitation process, hydrothermal process and spray decomposition process, in which a solution of a metal salt is used as a starting material, and a spray decomposition process, sol-gel process and crystallization process in glass, in which an organic metal compound is used.

No particular limitation is imposed on the form of the inorganic fine particles. With respect to the size of the inorganic fine particles, the average particle diameter is preferably 1 μm or smaller, more preferably 0.2 μm or smaller, still more preferably 0.1 μm or smaller.

As a process for combining the coloring material with the inorganic fine particles, may be applied a kneading process and mechanical alloying process, in which respective fine particles are mechanically mixed with each other under high shear, a process, in which the coloring material is heated and melted and then mixed with the inorganic fine particles, a process, in which the coloring material is solubilized and deposited on the inorganic fine particles from the solution thereof, a process, in which the coloring material is evaporated and deposited on the inorganic fine particles, and the like. In order to strengthen the bonding of the inorganic fine particles to the coloring material in the formation of the composite particles, the surfaces of the inorganic fine particles may also be treated with an alkoxysilane, silane coupling agent, titanate coupling agent or the like. Further, coloring agents in such a form that the inorganic fine particles have been already combined with the coloring material, such as Digit Color Blue, Digit Color Yellow, Digit Color Red and Digit Color Green (products of Toda Kogyo Corporation), may be used.

As for the form for coating the surfaces of the inorganic fine particles with the coloring material, the coloring material may be applied in the form of fine powder or may be coated in a state of a layer. Further,,the coloring material may be combined with the inorganic fine particles in such a form as being entered into the interior of each particle.

It is proper that the proportion of the coloring material combined with the inorganic fine particles is 10 to 500% by weight, preferably 30 to 300% by weight based on the weight of the inorganic fine particles. If the proportion of the coloring material is lower than 10% by weight, the resulting ink cannot achieve sufficient coloring. If the proportion of the coloring material exceeds 500% by weight on the other hand, the effect to make the particle diameter small is not brought about compared with the case where the coloring material is formed into particles by itself.

With respect to the size of the composite particles, the average particle diameter is preferably 500 nm or smaller, more preferably 200 nm or smaller, still more preferably 100 nm or smaller.

The proportion of the composite particles contained in the ink is preferably 0.1 to 20% by weight, more preferably 1 to 10% by weight based on the total weight of the ink. When the amount of the composite particles is 0.1 to 20% by weight, the resulting ink can provide a print having a preferable image density.

A principal solvent of the water-based ink according to the present invention is water. Distilled water, ion-exchanged water or the like may be used as the water. The proportion of water in the ink is preferably 40 to 95% by weight, more preferably 50 to 90% by weight based on the total weight of the ink.

The solvent of the water-based ink according to the present invention may contain any other water-soluble organic substance than water.

When the ink according to the present invention is used in an ink-jet printer, the organic substance acts on the prevention of solidification of the ink caused by drying at orifices. Specific examples thereof include alcohols such as isopropanol, butanol; diols such as ethylene glycol, diethylene glycol, triethylene glycol, tetraethylene glycol, propylene glycol, dipropylene glycol, tripropylene glycol, 1,2-butanediol, 1,3-butanediol, 1,4-butane diol, thiodiglycol, neopentyl glycol, 1,4-cyclohexanediol and polyethylene glycol; monoalkyl ethers of alkylene glycols, such as ethylene glycol monomethyl ether, ethylene glycol monoethyl ether, ethylene glycol monoisopropyl ether, ethylene glycol monoallyl ether, diethylene glycol monomethyl ether, diethylene glycol monoethyl ether, diethylene glycol monobutyl ether, triethylene glycol monomethyl ether, triethylene glycol monoethyl ether, propylene glycol monomethyl ether and dipropylene glycol monomethyl ether; polyols such as glycerol, 1,2,4-butanetriol, 1,2,5-pentanetriol, 1,2,6-hexanetriol, trimethylolethane, trimethylolpropane and pentaerythritol; cyclic ethers such as tetrahydrofuran and dioxane; and besides dimethyl sulfoxide, diacetone alcohol, glycerol monoallyl ether, N-methyl-2-pyrrolidone, 2-pyrrolidone, y-butyrolactone, 1,3-dimethyl-2-imidazolidinone, sulfolane, urea, β-dihydroxyethylurea, acetonylacetone, dimethylformamide, dimethylacetamide and phenoxyethanol.

These organic substances may be either solid or liquid so far as they are soluble in water. The Organic substances desirably have a boiling point higher than water, more desirably a boiling point of 120° C. or higher because they are required to remain in the ink even under such conditions as water is evaporated. However, they are not limited to high-boiling substances because they become hard to be evaporated owing to the interaction with the block copolymer compared with the case where they are present singly.

These organic substances may be used either singly. or in any combination thereof. The proportion of these organic substances in the ink is 5 to 50% by weight, preferably 10 to 30% by weight based on the total weight of the ink.

In the present invention, the water-insoluble coloring agent that is the composite particles of the coloring material and the inorganic fine particles, and the polymeric dispersing agent that is the block copolymer of the polyvinyl ether structure containing the hydrophilic segment and the hydrophobic segment are used as essential components. As a preferred mode of the present invention, is preferred a mode in which the water-insoluble coloring agent that is the composite particles of the coloring material and the inorganic fine particles is included in the amphiphilic block copolymer.

In order to improve dispersion stability and inclusion property, the molecular motion of the block copolymer is preferably more flexible because such a polymer becomes easy to physically entangle with the surface of the water-insoluble coloring agent and have affinity for the coloring agent. The block copolymer is preferably flexible even from the viewpoint of easy formation of a coating layer on a recording medium. Therefore, the glass transition temperature Tg of the main chain of the block copolymer is preferably 20° C. or lower, more preferably 0° C. or lower, still more preferably −20° C. or lower. In this regard, the polymer having the polyvinyl ether structure is preferably used because it generally has a low glass transition point and flexible properties. In the case bf the repeating unit structures illustrated above, most of them have a glass transition temperature of about −20° C. or lower.

Further, in order to realize the included state, a preferred form of the block copolymer used in the present invention is a polymer having a relatively high molecular weight, i.e., 6,000 or higher, preferably 9,000 or higher, more preferably 15,000 or higher in terms of a number average molecular weight. The number average molecular weight of the hydrophobic segment is 4,000 or higher, preferably 6,000 or higher. By taking such a form, the block copolymer is easy to take a stable micelle structure, and a coloring material can be satisfactorily dispersed by including the coloring material in a core part of the micelle or adsorbing the coloring material on a hydrophobic part. In particular, the environmental stability of the coloring material can be remarkably improved by including the coloring material. By this inclusion, the unstableness of ejection, which is considered to be derived from the unevenness as the surface characteristics of the coloring material, can be greatly inhibited. In the case of the water-insoluble coloring agent according.to the present invention, which is the composite particles of the coloring material and the inorganic fine particles, this effect is particularly great, and so the resulting ink is improved in the performance as an ink-jet ink. An ink in the included state can be prepared by any process so far as an amphiphilic block copolymer having a relatively high molecular weight, which is the block copolymer having the polyvinyl ether structure, is used. However, as a preferable example, the ink can be simply prepared by virtue. of the self-clustering nature of the amphiphilic block copolymer having a micelle-forming ability by uniformly dispersing the coloring agent and block copolymer according to the present invention in an organic solvent such as THF or DMF and adding water or aqueous alkali to the resultant dispersion.

The confirmation of the included state can be performed by various kinds of electron microscopes and/or instrumental analyses such as X-ray diffraction. In the case of the inclusion in a micelle state, the included state can be indirectly confirmed by the fact that the coloring agent and the copolymer are separately separated from the solvent under conditions of micelle collapse.

Various kinds of additives, for example, surfactants, pH adjustors, antioxidants, mildewproofing agents, etc. may be added to the ink according to the present invention in addition to the above-described components.

The ink according to the present invention can be prepared by adding the coloring agent particles and the block copolymer to a prescribed liquid medium and subjecting the resulting mixture to a dispersing treatment by means of application of an ultrasonic wave or a dispersing machine such as a beads mill or ball mill

The ink according to the present invention may be suitably used in an ink-jet recording method, in which energy is applied to an ink to eject it, thereby conducting recording. As the energy, may be used thermal energy or mechanical energy. However, the method using the thermal energy is particularly preferred.

A printer for ink-jet recording may be applied to a household printer, in which A4-sized paper is mainly used, a printer for business cards and cards, a large-scale printer for business use, or the like. However, it is suitably used to the large-scale printer of which particularly high image fastness properties are required, and which uses a great amount of an ink.

Examples of recording media, on which recording is conducted with the ink according to the present invention, include plain paper, on which no special coating is applied, the so-called ink-jet paper with at least one side thereof coated with an ink-receiving layer, postal cards, paper for business card, paper for label, corrugated cardboards and films for ink-jet.

A second embodiment of the present invention relates to an ink-applying process comprising the step of applying the ink described above to a recording medium. More specifically, the embodiment is an image-forming method comprising applying an ink to a recording medium, thereby forming an image, wherein the ink used is the ink described above.

A third embodiment of the present invention relates to an ink-applying apparatus comprising an ink-applying means for applying the ink described above to a recording medium by applying energy to the ink, and a driving means for driving the ink-applying means. More specifically, the embodiment is an image-forming apparatus for forming an image by applying an ink to a recording medium, wherein the ink used is the ink described above.

These embodiments will hereinafter be described in detail.

[Image-Forming Method and Image-Forming Apparatus]

The ink according to the present invention can be used in various kinds of image-forming apparatus by various printing methods, ink-jet methods or electrophotographic methods. A drawing of an image can be made by an image-forming method using such an apparatus.

In the present invention, examples of an ink-jet printer using an ink-jet ink include various ink-jet recording apparatus such as a piezo ink-jet system using a piezoelectric element and a Bubble-Jet (trademark) system that thermal.energy is applied to an ink to bubble the ink, thereby conducting recording.

In the image-forming apparatus according to the present invention, in the case of, for example, the ink-jet ink, the amount of the ink ejected from each ejection orifice of an ejection head is preferably within a range-of from 0.1 pl to 100 pl for improving the resolution of the resulting image

In the case of an ink-jet recording apparatus, as an embodiment thereof, the recording apparatus according to the present invention comprises a means for bringing the ink into contact with a composition which gives a stimulus for changing a solvent environment. According to this embodiment, the ink is fixed to a recording mediunr by this contact to form an excellent image.

The ink according to the present invention may be used in an indirect recording apparatus using a recording system in which an image is formed on an intermediate transfer medium with an ink, and the image is then transferred to a recording medium such as paper. The ink may also be applied to an apparatus utilizing an intermediate transfer medium according to the direct recording system.

The ink according to the present invention may also be used in an image-forming method and image-forming apparatus of an electrophotographic system. As an example of this image-forming apparatus, may be mentioned an apparatus comprising a photosensitive drum, on which a latent image is formed, a means (exposer or the like) for forming the latent image thereon, an ink-applying means, a transfer mechanism and a recording medium. The formation of an image by this apparatus is as follows. A latent image is first formed on the photosensitive drum, the ink according to the present invention is applied to the latent image or another portion than the latent image, and the resultant image is transferred to a recording medium by the transfer mechanism and fixed thereto.

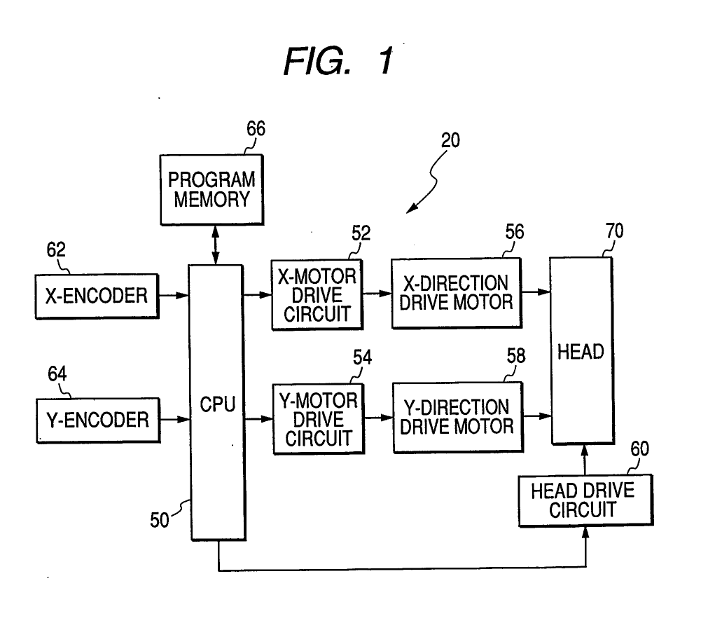

The ink-jet recording apparatus will hereinafter be schematically described by reference to FIG. 1. However, the construction shown in FIG. 1 is taken merely as an example, and the present invention is not limited thereby.

FIG. 1 illustrates the construction of an ink-jet recording apparatus.

FIG. 1 shows the case where a head is moved to conduct recording on a recording medium. In FIG. 1, an X-direction drive motor 56 and a Y-direction drive motor 58 for driving a head 70 in X and Y directions, respectively, are connected to CPU 50, which controls the overall operation of the recording apparatus, through an X-motor drive circuit 52 and a Y-motor drive circuit 54. The X-direction drive motor 56 and the Y-direction drive motor 58 are driven through the X-motor drive circuit 52 and the Y-motor drive circuit 54 according to an indication of CPU to determine the position of the head 70 to a recording medium.

As illustrated in FIG. 1, a head drive circuit 60 is connected to the head 70 in addition to the X-direction drive motor 56 and the Y-direction drive motor 58, and CPU 50 controls the head drive circuit 60 to drive the head 70, i.e., conduct ejection of an ink-jet ink, and the like. Further, an X-encoder 62 and a Y-encoder 64 for detecting the position of the. head 70 are connected to CPU 50 to input the positional information of the head 70. A control program is also inputted in a program memory 66. CPU 50 moves the head 70 on the basis of this control program and the positional information from the X-encoder 62 and the Y-encoder 64 to arrange the head 70 at a desired position over the recording medium so as to eject the ink-jet ink. A desired image can be drawn on the recording medium in such a manner. In the case of an image-recording apparatus capable of charging plural kinds of ink-jet inks, such a process as described above is conducted prescribed times for the respective ink-jet inks, whereby a desired image can be drawn on a recording medium.

After the ink-jet ink is ejected, the head 70 may also be moved to a position where a removing means (not illustrated) for removing an excessive ink attached to the head 70 is arranged, as needed, to clean the head 70 by wiping or the like. As a specific method of the cleaning, any conventional method may be used as it is.

After the drawing of the image is completed, the recording medium, on which the image has been drawn, is replaced with a new recording medium by a recording-medium-conveying mechanism (not illustrated).

In the present invention, the above-described embodiment may be changed or modified within limits not departing from the point thereof. For example, the head 70 may be moved only to the X direction (or Y direction), and the recording medium may be moved to the Y direction (or X direction) to draw an image while interlocking these movements, though the example where the head 70 is moved to both X and Y directions has been described in the above-described embodiment.

In the present invention, a head equipped with a means (for example, electrothermal converter or laser beam) for generating thermal energy as an energy source used for ejecting an ink-jet ink and ejecting the ink-jet ihk by the thermal energy brings about an excellent effect. According to such a system, high definition of the drawing can be achieved. Far excellent drawing can be made by using the ink-jet ink according to the present invention.

With respect to the typical construction and principle of the apparatus equipped with the means for generating the thermal energy, those using the basic principle disclosed in, for example, U.S. Pat. Nos. 44,723,129 and 4,740,796 are preferred. This system may be applied to any of the so-called On-Demand type and continuous type. In particular, the On-Demand type is effective because at least one driving signal which corresponds to ejection information and gives a rapid temperature rise exceeding nuclear boiling is applied to an electrothermal converter arranged corresponding to a liquid path, in which a liquid is retained, thereby causing the electrothermal converter to generate thermal energy to cause film boiling on the heat-acting surface of a head, so that a bubble can be formed in. the liquid in response to the driving signal in relation of one to one. The liquid is ejected through an ejection opening by the growth-contraction of this bubble to form at least one droplet. When the driving signal is applied in the form of a pulse, the growth-contraction of the bubble is rapidly and suitably conducted, so that the ejection of the liquid, which is excellent in responsiveness in particular, can be achieved. It is therefore more preferable to use such pulsed signals. As the pulsed driving signal, such signals as described in U.S. Pat. Nos. 4,463,359 and 4,345,262 are suitable. When the conditions described in U.S. Pat. No. 4,313,124 that discloses an invention relating to the rate of temperature rise on the heat-acting surface are adopted, far excellent ejection can be conducted.

As the construction of the head, such combined constructions (linear liquid flow path or perpendicular liquid flow path) of ejection openings, a liquid flow path and electrothermal converters as disclosed in the above-described publications, and besides constructions based on U.S. Pat. Nos. 4,558,333 and 4,459,600 which disclose the construction in which a heat-acting portion is arranged in a curved region may also be included in the present invention. In addition, the effect of the present invention is useful even for constructions based on Japanese Patent Application Laid-Open No. S59-123670 which discloses the construction in which a slit common to a plurality of electrothermal converters is used as an ejection part of the electrothermal converters, and Japanese Patent Application Laid-Open No. S59-138461 which discloses the construction in which an opening absorbing pressure wave of thermal energy is provided in opposition to an ejection part. Namely, the ejection of the ink-jet ink can be surely and efficiently conducted according to the present invention even if the head is in any form.

Further, the present invention may also be applied to a full-line type head having a length corresponding to the longest width of recording media. Both construction that the length is satisfied by a combination of plural recording heads and construction as one head integrally formed may be used as such a head.

In addition, the present invention is effective even when among those of the serial type, a head fixed to an apparatus body, or a replaceable chip type head in which electrical connection to the apparatus body and feed of an ink from the apparatus body become feasible by being installed in the apparatus body is used.

Further, the apparatus according to the present invention may additionally have a droplet-removing means. When such a means is equipped, a far excellent ejecting effect can be realized.

Moreover, the addition of preliminary auxiliary means, etc. as constitution of the apparatus according to the present invention is preferred because the effects of the present invention can be more stabilized. As specific examples thereof, may be mentioned capping means for the head, pressurizing or sucking means, preliminary heating means for conducting heating by electrothermal converters, other heating elements than these or combinations thereof, and preliminary ejecting means for conducting ejection different from ejection of an ink.

In the present invention, it is most effective to perform the above-described film boiling system.

The present invention will hereinafter be described by the following specific examples. However, the present invention is not limited at all by these examples.

(1) Synthesis of ABC Triblock Copolymer:

After the interior of a glass container equipped with a three-way stop-cock was purged with nitrogen, the container was heated to 250° C. under a nitrogen gas atmosphere to remove adsorbed water. After the system was returned to room temperature, 12 mmol of 1-isobutoxyethyl vinyl ether, 16 mmol of ethyl acetate, 0.1 mmol of 1-isobutoxyethyl acetate and 11 ml of toluene were added. At the time the temperature within the system was cooled to 0° C., 0.2 mmol of ethylaluminum sesquichloride was added to initiate polymerization, thereby synthesizing a component A of a triblock copolymer. The molecular weight was periodically monitored by means of gel permeation chromatography (GPC; HLC-8220 manufactured by Tosoh Corp.). After completion of the polymerization of the component A, 12.0 mmol of 2-methoxyethyl vinyl ether that is a component B was added to continue the polymerization. Completion of the polymerization of a component B was confirmed by monitoring by means of GPC in the same manner as described above. Then, 10 mmol of ethyl 4-(2-vinyloxyethoxy)benzoate that is a component C was added to continue the polymerization. The termination of the polymerization reaction was conducted by adding a 0.3% by weight solution of ammonia/methanol into the system. The identification of the triblock copolymer thus obtained was conducted by means of a nuclear magnetic resonance absorption measurement apparatus (NMR, DPX400 manufactured by Bruker Biospin Co.) and GPC. Both analyses revealed that the intended substance had been synthesized. The number average molecular weight (Mn) of the resultant triblock copolymer was 30,000 in terms of standard polystyrene, and the ratio (Mw/Mn) of weight average molecular weight (Mw)/number average molecular weight (Mn) that indicates the degree of a molecular weight distribution was 1.3.

The ester portion of the component C of this triblock polymer was hydrolyzed with a mixture of an aqueous solution of 5 times equivalent sodium hydroxide and methanol, and the solvent was distilled off to obtain a polymer in the form of a carboxylic acid.

(2) Synthesis of AB Diblock Copolymer:

After the interior of a glass container equipped with a three-way stop-cock was purged with nitrogen, the container was heated to 250° C. under a nitrogen gas atmosphere to remove adsorbed water. After the system was returned to room temperature, 12 mmol of isobutyl vinyl ether, 16 mmol of ethyl acetate, 0.1 mmol of 1-isobutoxyethyl acetate and 11 ml of toluene-were added. At the time the temperature within the system was cooled to 0° C., 0.2 mmol of ethylaluminum sesquichloride was added to initiate polymerization, thereby synthesizing a component A of a diblock copolymer. The molecular weight was periodically monitored by means of gel permeation chromatography (GPC; HLC-8220 manufactured by Tosoh Corp.). After completion of the polymerization of the component A, 12.0 mmol of 2-methoxyethyl vinyl ether that is a component B was added to conduct polymerization of the component B. The termination of the polymerization reaction was conducted by adding a 0.3% by weight solution of ammonia/methanol into the system. The identification of the diblock copolymer thus obtained was conducted by means of a nuclear magnetic resonance absorption measurement apparatus (NMR, DPX400 manufactured by Bruker Biospin Co.) and GPC. Both analyses revealed that the intended substance had been synthesized. The number average molecular weight (Mn) of the resultant diblock copolymer was 25,000 in terms of standard polystyrene, and the ratio (Mw/Mn) of weight average molecular weight (Mw)/number average molecular weight (Mn) that indicates the degree of a molecular weight distribution was 1.3.

(3) Synthesis of Silica Particles:

A glass container kept at 10° C. was charged with 100 ml of 24% aqueous ammonia and 1.5 liters of ethanol, and 1 liter of a 20% ethanol solution of tetraethyl orthosilicate was gradually added over 1 hour with stirring. A white precipitate formed was separated by filtration, dried and then subjected to a heat treatment at 300° C. to obtain silica particles. The particles thus obtained were spherical and had an average particle diameter of about 80 nm.

(4) Synthesis of Titania Particles:

The interior of a stainless steel container equipped with an atomizing tube having an ultrasonic oscillator at a bottom and a nozzle at an upper part was purged with dry nitrogen, and 500 ml of a 5% ethanol solution of titanium tetraisopropoxide was introduced in the container kept at 0° C. Nitrogen gas was introduced into the container at the same time as the operation of the ultrasonic oscillator to atomize the solution of titanium tetraisopropoxide from the nozzle of the atomizing tube into a vessel kept at a humidity of 50%. After titanium oxide formed in the form of powder was colleted, subjected to a heat treatment at 450° C. for 4 hours and then dispersed in water to remove coarse particles high in sedimentation velocity, the residue was dried to obtain fine titania particles. The particles thus obtained were spherical and had an average particle diameter of about 100 nm.

(5) Production of Composite Particles 1:

Fifty grams of the silica particles described above were placed in a blade type kneader, and 1 g of methyltriethoxysilane was poured to mix them for 1 hour. Then, 25 g of C.I. Pigment Blue 15:3 was gradually added over 4 hours, and the contents were kneaded to obtain composite particles of the coloring material and the silica. The particles thus obtained had an average particle diameter of about 100 nm and were spherical. Undefined particles composed of the pigment alone were scarcely observed through a scanning electron microscope.

(6) Production of Composite Particles 2:

Composite particles of a coloring material and the silica were obtained in the same manner as in the production of Composite Particles 1 except that Carbon Black MA8 was used in place of C.I. Pigment Blue 15:3. The particles thus obtained had an average particle diameter of about 100 nm.

(7) Production of Composite Particles 3:

Composite particles of the coloring material and the titania particles described above were obtained in the same manner as in the production of Composite Particles 1 except that the titania particles were used in place of the silica particles. The particles thus obtained had an average particle diameter of about 120 nm.

### EXAMPLE 1

One part by weight of the above-described triblock copolymer neutralized with an alkali was dissolved in 9 parts by weight of N,N-dimethylformamide, and the resultant solution was mixed with a dispersion of 1 part by weight of Composite Particles 1 in 18 parts by weight of water to disperse the particles in the liquid medium by application of an ultrasonic wave. Thereafter, N,N-dimethylformamide was removed by a rotary evaporator, and 2 parts by weight of diethylene glycol and 2 parts by weight of glycerol were added to the residue to obtain a water-based ink.

### EXAMPLE 2

A water-based ink was obtained in the same manner as in EXAMPLE 1 except that Composite Particles 2 were used in place of Composite Particles 1.

### EXAMPLE 3

A water-based ink was obtained in the same manner as in EXAMPLE 1 except that Composite Particles 3 were used in place of Composite Particles 1.

### EXAMPLE 4

A water-based ink was obtained in the same manner as in EXAMPLE 1 except that Digit Color Blue (product of Toda Kogyo Corporation) was used in place of Composite Particles 1.

### EXAMPLE 5

One part by weight of the above-described diblock copolymer was dissolved in 9 parts by weight of N,N-dimethylformamide, and the resultant solution was mixed with a dispersion of 1 part by weight of Digit Color Blue (product of Toda Kogyo Corporation) in 18 parts by weight of water to disperse the coloring material particles in the liquid medium by application of an ultrasonic wave. Thereafter, N,N-dimethylformamide was removed by a rotary evaporator, and 2 parts by weight of diethylene glycol and 2 parts by weight of glycerol were added to the residue to obtain a water-based ink.

### COMPARATIVE EXAMPLE 1

One part by weight of a styrene-maleic acid random copolymer (number average molecular weight: 10,000) was dissolved in 9 parts by weight of N,N-dimethylformamide, and the resultant solution was mixed with a dispersion of 1 part by weight of Composite Particles. 1 in 18 parts by weight of water to disperse the particles in the liquid medium by application of an ultrasonic wave. Thereafter, N,N-dimethylformamide was removed by a rotary evaporator, and 2 parts by weight of diethylene glycol and 2 parts by weight of glycerol were added to the residue to obtain a water-based ink.

### COMPARATIVE EXAMPLE 2

A water-based ink was obtained in the same manner as in COMPARATIVE EXAMPLE 1 except that Digit Color Blue (product of Toda Kogyo Corporation) was used in place of Composite Particles 1.

[Evaluation]

The water-based inks obtained in EXAMPLES 1 to 5 and COMPARATIVE EXAMPLES 1 and 2 were separately charged into an ink-jet recording apparatus, BJF-660 (trade name, manufactured by Canon Inc.) which ejects an ink by application of thermal energy, and printing was conducted on gloss paper, SP101 (trade name, product of Canon Inc.). After each of the inks was kept for 1 week in a state charged into the ink-jet recording apparatus as it is, a printing test was conducted in the same manner as described above to compare the results of the respective tests. The results are shown in Table 1.

TABLE 1

| | Ejection | | | | | |
|---|---|---|---|---|---|---|
| | property*¹ | | Color tone*² | | | |
| | Right after | | Right after | | | |
| | prepa- | After 1 | prepa- | After 1 | Light*³ | Water*⁴ |
| | ration | week | ration | week | fastness | fastness |
| EX. 1 | AA | AA | AA | AA | A | A |
| EX. 2 | AA | AA | AA | AA | A | A |
| EX. 3 | AA | AA | AA | AA | A | A |
| EX. 4 | AA | AA | AA | AA | A | A |
| EX. 5 | AA | AA | AA | AA | A | A |
| COMP. | B | C | B | Impossible | A | C |
| EX. 1 | | | | of | | |
| | | | | evaluation | | |
| COMP. | B | C | B | Impossible | A | C |
| EX. 2 | | | | of | | |
| | | | | evaluation | | |

The dispersion in EXAMPLE 1 was applied to a silicon substrate to observe it through a scanning electron microscope. As a result, it was found that the fine particles are coated with the polymer in an included state. Two inks of those prepared in the same manner as in the preparation of the ink in EXAMPLE 5, except that (1) N,N-dimethylformamide was not used, or (2) the coloring agent was changed to C.I. Pigment Blue 15:3 itself, were produced. The ink of (1) was such that the ejection property was ranked as “B” right after the preparation or “C” after 1 week, but other properties were equivalent to those in EXAMPLE 1. The ink of (2) was such that the color tone was ranked as “B” right after the preparation or “C” after 1 week.

*1: Ejection Property:

After a 100% solid image was printed at ordinary temperature, and the printing was suspended for 1 minute, a 100% solid image was printed again to evaluate the image in accordance with the following standard.
AA: No white stripe was observed, and printing was normally conducted;
A: White stripes were slightly observed;
B: White stripes were-observed on the whole image;
C: The image was scarcely printed.
   *2: Color Tone:

A 100% solid image was printed at ordinary temperature to visually evaluate the brightness of the color with 4 ranks.
AA: The color tone was ideal;
A: The color tone was almost good, but the color somewhat looked dark and dull;
B: The dulling of the color was easily recognized;
C: The color tone became completely turbid.
   *3: Light Fastness:

The print was exposed for 100 hours to a xenon lamp, and a reflection density of the image was then measured to find a remaining rate of the reflection density compared with the reflection density before the test, thereby evaluating the light fastness in accordance with the following standard.
A: The remaining rate of the density was not lower than 98%;
B: The remaining rate of the density was not lower than 90%, but lower than 98%.
C: The remaining rate of the density was lower than 90%.
   *4: Water Fastness:

After 12 hours from the printing, the print was left at rest for 5 minutes in tap water and dried to measure a reflection density of the image. A remaining rate of the reflection density compared with the reflection density before the test was found to evaluate the water fastness in accordance with the following standard.
A: The remaining rate of the density was not lower than 95%;
B: The remaining rate of the density was not lower than 90%, but lower than 95%.
C: The remaining rate of the density was lower than 90%.

As described above, the inks according to the present invention can provide prints high in image fastness properties such as water fastness and light fastness, are excellent in coloring ability and storage stability and can be used as inks for ink-jet recording.

The ink-applying process and ink-applying apparatus according to the present invention can provide prints high in image fastness properties such as water fastness and light fastness using the inks described above and can be used as ink-jet recording methods and recording apparatus.

This application claims priority from Japanese Patent Application No. 2003-381041 filed on Nov. 11, 2003, which is hereby incorporated by reference herein.

1. An ink comprising a coloring agent composed of composite particles of a coloring material and inorganic fine particles, a polymeric dispersing agent and a solvent, wherein the polymeric dispersing agent is composed of a block copolymer of a polyvinyl ether structure having a hydrophilic segment and a hydrophobic segment.

2. The ink according to claim 1, wherein the coloring agent is included in the block copolymer.

3. The ink according to claim 1 or 2, wherein the block copolymer has a number average molecular weight of 6,000 or higher.

4. The ink according to claim 3, wherein the hydrophobic segment has a number average molecular weight of 4,000 or higher.

5. The ink according to claim 1, wherein the proportion of the hydrophilic segment to the hydrophobic segment falls within ranges of from 10 to 90% by mole to from 90 to 10% by mole.

6. The ink according to claim 1, wherein the proportion of the block copolymer falls within a range of from 0.001 to 40% by weight based on the total weight of the ink.

7. The ink according to claim 1, wherein the inorganic fine particles have an average particle diameter of 1 μm or smaller.

8. The ink according to claim 1, wherein the composite particles have an average particle diameter of 500 nm or smaller.

9. The ink according to claim 1, wherein the coloring material is a pigment.

10. The ink according to claim 1, wherein the inorganic fine particles are composed of an oxide.

11. The ink according to claim 1, wherein the coloring agent is composed of the composite particles with the surfaces of the inorganic fine particles coated with the coloring material.

12. An ink-applying process comprising the step of applying the ink according to claim 1 to a recording medium.

13. An ink-applying apparatus comprising an ink-applying means for applying the ink according to claim 1 to a recording medium by applying energy to the ink, and a driving means for driving the ink-applying means.
